(19) United States
(12) Patent Application Publication
(10) Pub. No.: US 2020/0244693 A1
(43) Pub. Date: Jul. 30, 2020

(54) SYSTEMS AND METHODS FOR CYBERSECURITY RISK ASSESSMENT OF USERS OF A COMPUTER NETWORK

(71) Applicant: UNIVERSITY OF NEW BRUNSWICK, Fredericton (CA)

(72) Inventors: Aliakbar GHORBANI, Fredericton (CA); Arash HABIBI LASHKARI, Fredericton (CA); Mohammad Saiful Islam MAMUN, Fredericton (CA); Gerard Draper GIL, Algaida (ES)

(21) Appl. No.: 16/753,301

(22) PCT Filed: Jul. 19, 2019
(86) PCT No.: PCT/CA2019/051002

§ 371 Date: Apr. 2, 2020

Related U.S. Application Data
(60) Provisional application No. 62/702,778, filed on Jul. 24, 2018.

(51) Int. Cl. H04L 29/06; G06F 21/57

(52) U.S. Cl. CPC H04L 63/1433; G06F 21/577; H04L 63/20

(57) ABSTRACT

Systems and methods are provided for determining the security risk associated with one or more users of a computer network. Users are monitored over time to build security related profiles which are employed to assess the risk they impose on the network. The user profiles, which may be computed as online and network user profiles for each user, are processed to classify users according to user groups. A composite risk measure is generated, for a given user, based on a first measure that is obtained by processing the user profile data, and a second security risk measure, that is obtained by comparing the present user group to which the user has classified and a prior user group that was associated with the given user. Action may be taken by an administrator to mitigate the risk posed by that user based on the computed composite risk score.

### CROSS-REFERENCE TO RELATED APPLICATION

This application claims priority to U.S. Provisional Patent Application No. 62/702,778, titled “SYSTEMS AND METHODS FOR CYBERSECURITY RISK ASSESSMENT OF USERS OF A COMPUTER NETWORK” and filed on Jul. 24, 2018, the entire contents of which is incorporated herein by reference.

### BACKGROUND

This present disclosure relates generally to cybersecurity.

Currently, there are a large number of network security related software solutions that can detect malicious activities on a network. An attack on a network typically occurs when a user is lax in his/her security habits, thereby becoming a vector for the attack to occur. For example, a user on a network may disable the firewall on the computer, thereby providing an opening for attackers. While existing security tools can respond to attacks or administrator rules (such as the disabling of a firewall), these reactive measures unfortunately fail to provide a suitable mechanism for preventing cyberattacks.

### SUMMARY

Systems and methods are provided for determining the security risk associated with one or more users of a computer network. Users are monitored over time to build security related profiles which are employed to assess the risk they impose on the network. The user profiles, which may be computed as online and network user profiles for each user, are processed to classify users according to user groups. A composite risk measure is generated, for a given user, based on a first measure that is obtained by processing the user profile data, and a second security risk measure, that is obtained by comparing the present user group to which the user has been classified and a prior user group that was associated with the given user. Action may be taken by an administrator to mitigate the risk posed by that user based on the computed composite risk score.

Accordingly, in one aspect, there is provided a system for assessing security risk associated with a computer network, the system comprising:

a risk assessment database; and

a risk analysis subsystem operably connected to said risk assessment database and one or more data sources, wherein the one or more data sources comprise user activity data, wherein the risk analysis system comprises at least one processor and associated memory, wherein the memory stores instructions executable by the at least one processor for performing operations comprising:
monitoring the one or more data sources to obtain user activity data associated with users of the computer network;
processing the user activity data to generate a plurality of user profiles, wherein each user profile is associated with a respective user;
processing the user profiles to classify the users into a plurality of user groups, each user group having an associated risk level;
storing the user profiles and the user groups in the risk assessment database; and
generating a composite security risk measure associated with a given user, wherein the composite security risk measure is generated, at least in part, by combining:
   a first security risk measure generated by processing the user profile associated with the given user; and
   a second security risk measure based on a comparison between a current user group associated with the given user and a previous user group associated with the given user.

In another aspect, there is provided a method for assessing security risk associated with a computer network, the method comprising:
monitoring the one or more data sources to detect user activity data associated with users of the computer network;
processing the user activity data to generate a plurality of user profiles, wherein each user profile is associated with a respective user;
processing the user profiles to classify the users into a plurality of user groups, each user group having an associated risk level;
storing the user profiles and the user groups in a risk assessment database; and
generating a composite security risk measure associated with a given user, wherein the composite security risk measure is generated, at least in part, by combining:
   a first security risk measure generated by processing the user profile associated with the given user; and
   a second security risk measure based on a comparison between a current user group associated with the given user and a previous user group associated with the given user.

A further understanding of the functional and advantageous aspects of the disclosure can be realized by reference to the following detailed description and drawings.

### BRIEF DESCRIPTION OF THE DRAWINGS

Embodiments will now be described, by way of example only, with reference to the drawings, in which:

FIG. 1 illustrates an example system for performing security risk analysis for one or more users of a network.

FIG. 2 provides a schematic of an example cybersecurity monitoring system according to one example embodiment of the present disclosure

FIG. 3 is a flowchart disclosing an example method of assessing security risk associated with a user of a monitored computer network.

FIG. 4 illustrates an example implementation of a method for performing security risk analysis.

FIG. 5 illustrates example database schema for the user profile data and the user group data.

FIG. 6A illustrates an activities diagram of hourly updates to the network profiles of individual users.

FIG. 6B illustrates an activities diagram of daily updates to the online profile (onl) of individual users.

FIG. 7 is a table that prescribes weights for different levels of user expertise.

FIG. 8 is a table that quantitates roles within an organization.

FIG. 9 is a table that correlates a risk level with user alias.

FIG. 10 is a table that correlates risk level with access to network assets.

FIG. 11 is a table that provides access power weights for different combinations of alias and asset values.

FIG. 12 is a table that prescribes risks levels for different categories of X-force.

FIG. 13 is a table that associates risk with movement of a user from one group to another group.

FIG. 14 is a table that lists an example set of online threats and associated threat scores.

FIG. 15 is a table that lists an example set of network threats and associated threat scores.

FIG. 16 is a table that lists an example set of behavioral vulnerabilities and their associated threats.

FIG. 17 is a table that lists an example set of common vulnerabilities and their associated threats.

FIG. 18 is a table that associates vulnerabilities with a set of threats pertaining to an example user.

FIG. 19 is a table that lists an example set of impact factors.

FIG. 20 is a table illustrating the calculation of impact scores for two example threats.

FIG. 21 is a table that demonstrates the calculation of T*1 for an example user.

FIGS. 22A and 22B plot examples of the scaling of the composite risk factor for a given user.

FIG. 23 shows example components of a risk analysis subsystem.

FIG. 24 is a table presenting example risk mitigation recommendations.

FIG. 25 is a table presenting example risk mitigation actions.

### DETAILED DESCRIPTION

Various embodiments and aspects of the disclosure will be described with reference to details discussed below. The following description and drawings are illustrative of the disclosure and are not to be construed as limiting the disclosure. Numerous specific details are described to provide a thorough understanding of various embodiments of the present disclosure. However, in certain instances, well-known or conventional details are not described in order to provide a concise discussion of embodiments of the present disclosure.

As used herein, the terms “comprises” and “comprising” are to be construed as being inclusive and open ended, and not exclusive. Specifically, when used in the specification and claims, the terms “comprises” and “comprising” and variations thereof mean the specified features, steps or components are included. These terms are not to be interpreted to exclude the presence of other features, steps or components.

As used herein, the term “exemplary” means “serving as an example, instance, or illustration,” and should not be construed as preferred or advantageous over other configurations disclosed herein.

As used herein, the terms “about” and “approximately” are meant to cover variations that may exist in the upper and lower limits of the ranges of values, such as variations in properties, parameters, and dimensions. Unless otherwise specified, the terms “about” and “approximately” mean plus or minus 25 percent or less.

It is to be understood that unless otherwise specified, any specified range or group is as a shorthand way of referring to each and every member of a range or group individually, as well as each and every possible sub-range or sub-group encompassed therein and similarly with respect to any sub-ranges or sub-groups therein. Unless otherwise specified, the present disclosure relates to and explicitly incorporates each and every specific member and combination of sub-ranges or sub-groups.

As used herein, the term “on the order of”, when used in conjunction with a quantity or parameter, refers to a range spanning approximately one tenth to ten times the stated quantity or parameter.

As noted above, many currently available network security solutions that are based on reactive measures, as opposed to proactive measures, are limited in their ability to counter cyberattacks. Indeed, one of the key shortcomings of such network security solutions is their inability to provide an estimate of network users who are vulnerable to future cyberattacks. In order to attempt to identify which users represent the greatest risk to the security of a network, an administrator could examine a list of users and identify those that have previously acted as attack vectors, flagging them as potential security risks. This approach nonetheless relies on past cyberattacks to predict future adverse events, which is also reactive in nature as a solution and therefore inherently limited.

The present inventors, in seeking a solution to the aforementioned problem, realized that the while the detection of user vulnerability could be a useful aspect of cybersecurity risk analysis system, the prognostic power of such a system could be significantly improved by considering the behaviors and habits of users relative to those of other users of a network, rather than merely in isolation, when assessing cybersecurity risk associated with a given user. The present inventors also realized that the prognostic power of a cybersecurity risk analysis system could also or alternatively be augmented by developing user profiles, for use in subsequent cybersecurity risk analysis, that are based on the detection of both online (e.g. involving a remote wide-area network) and network (i.e. involving the network environment to be monitored) user activity, such that the determination of cybersecurity risk associated with a given user involves both online-related and network-related user activity. As further described in detail below, the present inventors also developed a modality for the calculation of per-user cybersecurity risk that involves the calculation of a numerical risk score based on the processing of several associated risk measures.

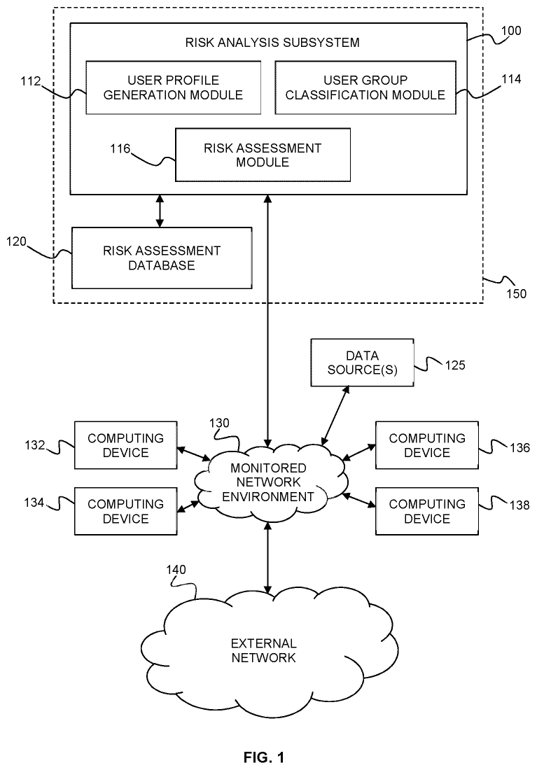

Referring now to FIG. 1, an example system for assessing the risk associated with a computer network is shown. The example system includes a risk analysis subsystem 100, which is interfaced with (operably connected to) a network environment 130 that is to be monitored, a risk assessment database 120 and one or more data sources 125. The risk assessment database 120 stores user profile data associated with the monitoring of user activity, and the one or more data sources 125 provide user activity data (e.g. based on events and domains associated with user actions). The risk assessment database 120 may reside on one or more storage devices that are physically remote from the risk analysis subsystem 100, or may reside on internal storage media associated with the risk assessment subsystem (as shown, for example by 150 in FIG. 1). Non-limiting examples of data sources include network traffic, application usage, social media activities, memory, CPU and I/O usage patterns, proxy server logs or browsing activities.

As described in further detail below, the risk analysis subsystem 100 includes a processor and a memory, where the processor is configured to execute instructions stored in the memory in order to compute cybersecurity risk measures based on the processing of user profile data stored in the risk assessment database 120, as represented by risk assessment module 116. The cybersecurity risk analysis subsystem 100 also includes a user profile generation module 112 that generates user profile data based on the processing of user activity data provided by the one or more data sources 125, and a user group classification module 114 that classifies users into user groups based on the processing of the user profile data. Each user group may be processed to determine a different group risk measure associated therewith.

FIG. 1 illustrates an example of a network environment 130 that provides connectivity for a plurality of example computing devices 132-138, which may include computing devices such as, but not limited to, desktop and mobile computers, servers, storage devices, networking hardware/equipment (e.g. routers, gateways, bridges, repeaters, and firewalls), smartphones, tablets, Personal Digital Assistant (PDA) and other computing devices. It will be understood that FIG. 1 illustrates one heuristic example of a system for monitoring a network environment 130, and that additional components can be added and/or existing components can be removed.

The network environment 130 can include any number of computer devices, which may be connected by one or more local area networks and/or one or more wide area networks, wired or wireless. Also, it may include remote computing devices that are connected through the internet by different methods such as, but not limited to, IPSec VPN, SSL VPN or Microsoft Direct Access. The network environment 130 may represent computer systems and network hardware associated entities such as, but not limited to, individuals, businesses, corporations, governmental agencies, non-profit organizations, hospitals, education institutions. The network environment 130 may be connected or connectable to one or more external networks 140.

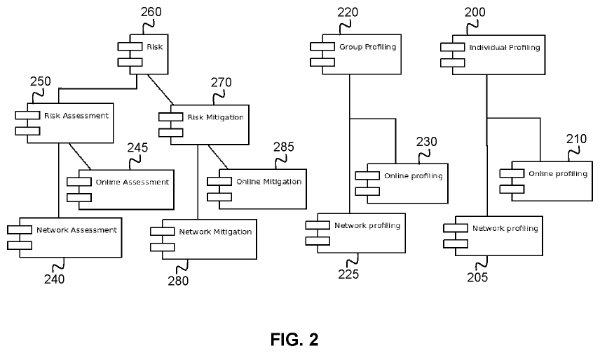

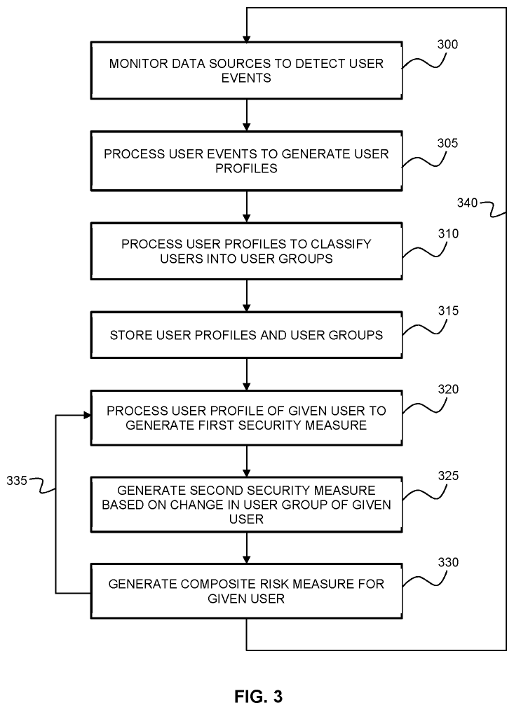

Referring now to FIGS. 2 and 3, FIG. 2 provides a schematic of an example cybersecurity monitoring system according to one example embodiment of the present disclosure and FIG. 3 is a flowchart disclosing an example method of assessing security risk associated with a user of a monitored computer network. The example method, and/or variations thereof, may be executed by the risk analysis subsystem 100 of FIG. 1.

Referring first to step 300 of FIG. 3, user activity associated with actions of users of the monitored network is detected, for example, via the monitoring of one or more data sources that log user activity data. The user activity data is processed, as shown at 305, to generate user profiles, shown at 200 in the schematic of FIG. 2. As shown at 205 and 210 in FIG. 2, separate user profiles may be generated, for one or more users, based on the processing of online user activity data (e.g. user activity data involving a remote wide-area network—e.g. the internet) and network activity data (i.e. user activity data involving the network environment to be monitored). The user profiles are stored in the risk analysis database, as shown at 315 in FIG. 3.

As shown at 310 in FIG. 3, the user profiles are processed to classify users into a plurality of user groups, as shown at 220 in FIG. 2, where each group may have an associated risk level. Example methods of performing user classification are described below. As shown at 225 and 230 in FIG. 2, separate user groups may be generated based on the processing of online user profiles and network user profiles. The user groups may be stored in the risk analysis database, as shown at 315 in FIG. 3.

In order to generate a risk measure (shown at 260 in FIG. 2) associated with a given user of the monitored network, the user profile associated with the given user may be processed to generate a first risk measure, as shown at 320 in FIG. 3. A second risk measure may be generated based on a comparison between a current user group of the given user and a previous (past, historical) user group of the current user, as shown at 325 in FIG. 3. A composite risk measure associated with the given user is then generated, as shown at 330, where the composite risk measure is based on at least the first risk measure and the second risk measure. These steps are associated with the risk assessment 250 shown in FIG. 2. As indicated in FIG. 2, the risk assessment may involve the calculation of a network risk measure 240 and an online risk measure 245.

Referring again to FIG. 3, the generation of the composite risk measure may be repeated, as shown at 335, for a plurality of users of the monitored network, thereby generating a per-user composite risk measure for many users (e.g. each user) of the plurality of users. It will be understood that the generation of the user profiles, the classification of the users into user groups, and the generation of the composite risk measures may be repeated to provide continuous, real-time, or intermittent (e.g. periodic or aperiodic) assessment of cybersecurity risk. While FIG. 3 illustrates an example embodiment in which the overall process is repeated sequentially as shown at 340, it will be understood that in other example embodiments, the update rate (e.g. frequency or interval) may differ for the updating of user profiles, user groups, and composite risk measures. For example, the user profiles may be updated more frequently than the updating of the user groups. In one example, the user group classification is performed daily, while the processing of the user activity data (obtained from the one or more data sources) to generate the user profiles is performed on a more frequent basis, such as hourly. Furthermore, some aspects of a user profile may be updated at a faster rate than other aspects (e.g. some daily, while others hourly). In other example embodiments, the recalculation of the user groups is only performed after detecting a recalculation of one or more user profiles.

In some example embodiments, the frequency of re-assessment for a given user may be dependent on the most recently determined cybersecurity risk measure for the given user, such that users having higher prognostic cybersecurity risk are re-assessed on a more frequent basis than users having a lower prognostic cybersecurity risk.

In the event that the composite risk measure exceeds (crosses) a threshold for a given user, the risk analysis subsystem may communicate the presence of the cybersecurity risk associated with the user. For example, one or more alerts and/or messages may be generated and/or transmitted to an authorized operator.

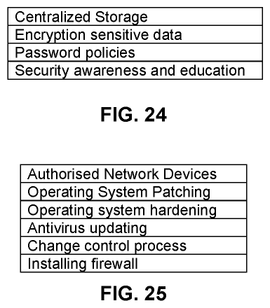

The system may be configured to generate and provide a risk mitigation recommendation and/or perform a risk mitigation action based on the composite security risk measure associated with the given user, as shown at 270, 280 and 285 in FIG. 2. Examples risk mitigation recommendations include those shown in the table provided in FIG. 24. Examples risk mitigation actions include those shown in the table provided in FIG. 25.

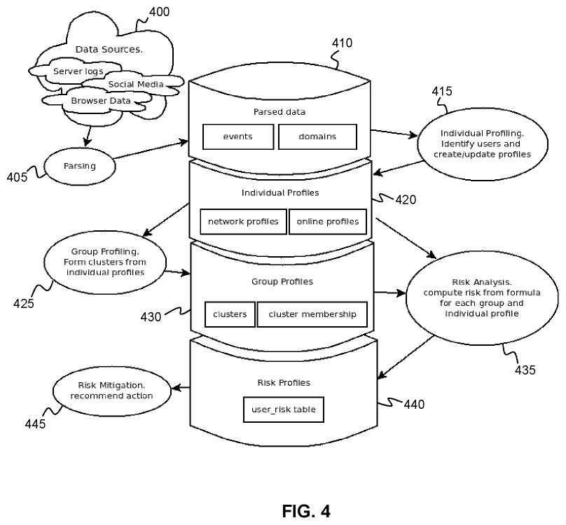

Referring now to FIG. 4, an example schematic is provided that illustrates a method of performing cybersecurity risk analysis and the optional subsequent mitigation of risk. User activity data is obtained from the one or more data sources 400 and parsed into events and domains, as shown at 405. The parsing of the user activity data from various sources is saved, optionally to the risk assessment database, in a unified format. As various input sources of information may list information in a different order from another source, one source may omit information, or different delimiters may be used, the data may not be suitable for processing it is raw format, and the parser may be provided to generate a unified dataset in common format.

The parsed user activity data, shown at 410, is processed, as shown at 415, to generate user profiles network and online profiles at 420. For example, the input data is examined and information is collected on users to generate a user profile for one or more (or each) user. For example, in one non-limiting example implementation, the user profile associated with a given user may be determined by:

collecting all data related to user “A”, counting how many data points A has, and finding A's first and last events of the current day. In some example implementations, some operations may need to be deferred until the end of the day when all daily events have been collected, such as finding the total time spent online. The user profiles may be stored on the risk assessment database.

The user profiles are processed, as shown at 425, to classify the users into network and online user groups, optionally generating user group profiles as shown at 430. As noted above, the classification may be performed according to a clustering algorithm. The user profiles and user groups are then processed, as shown at 435, to generate, for at least one user, a composite cybersecurity risk measure, and optionally a risk profile, as shown at 440. In the event of the identification of a potential cybersecurity risk associated with one or more users, the risk may be communicated, and one or more risk mitigation actions may be recommended and/or performed, as shown at 445. It will be understood that the components of the system shown in FIG. 4 may be implemented as separate sub-modules within the risk analysis subsystem, each performing one step of the process above from input data through to final output.

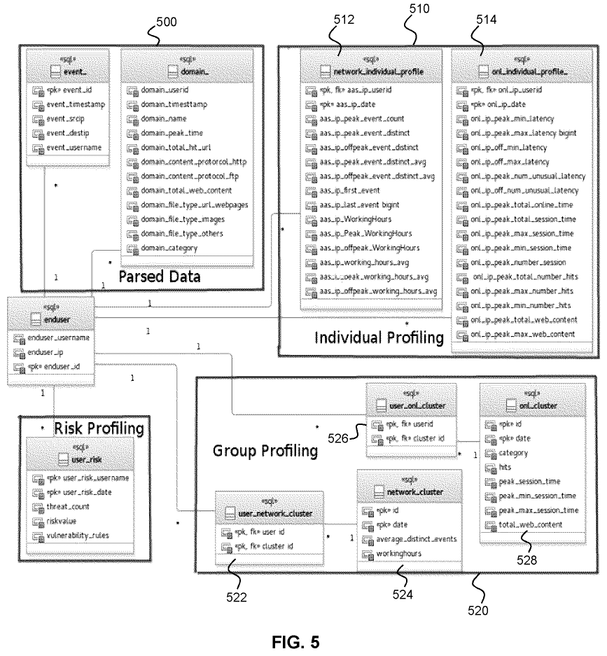

FIG. 5 illustrates example database schema for the user profile data and the user group data, showing an example of the generation and organization of user profile data and the classification of the user profiles into user groups. As shown at 500, user activity data, obtained from the one or more data sources, is obtained and optionally parsed prior to further processing. The example parsed data shown at 500 is parsed into user event data and user domain data. The user data is then processed to generate user profile data, resulting in a set of user profiles 510 associated with respective users of the monitored computer network. In the non-limiting example shown in FIG. 5, the both network-specific user profiles 512 and online-specific user profiles 514 are generated. It will be understood, however, that in other example implementations, other types of user profiles may be generated, or a single user profile (per user) may be generated in the alternative.

The user profile data may be generated according to a wide range of example methods, with the user profile example shown in FIG. 5 representing but one example. The user profile data shown in FIG. 5 is intended to show, for illustrative purposes, merely a portion (subset) of the user profile data that could be generated for a given user (for example, the list 512 does not end at the bottom of the window shown in the figure).

As shown in the example implementation presented in FIG. 5, the results of the data collected from parsing incoming network activities may be stored in two tables, an “event” table and a group “domain”. For each user observed in incoming data, a new entry is added (if necessary) in the “enduser” table with a unique user id. The “event” table is provided for storing general information relating to activities on the network to build network individual profiles, and includes fields for username, time of occurrence (stored as epoch time), and the source and destination IP addresses. The “domain” table stores information pertaining to the domains that a user has visited online. In one example implementation, in one day, for each user, there will be a single row in the domain table for every domain they have visited that same day.

The present non-limiting example shown in FIG. 5 presents examples of domain data that is stored, including:
domain name
   (name of domain)
domain_peak_time
   (if domain was visited during peak hours)
domain_total_web_content
   (total bytes of data received)
domain_file_type_image
   (total bytes of images received)
domain_content_protocol_http
   (total bytes received using http protocol)
domain_category
   (Category of domain. ex: social media, shopping, news).

The example database schema shown in FIG. 5 also includes the table “network_individual_profile”, which is employed to store information about each users activities on the monitored network. Each profile may be uniquely identified by a “user ID” and a date primary key. The profile information is obtained by querying the “events” table and iterating over the rows of queries that result.

Examples of network individual profile features include the following:
aas_ip_peak_event_count
   (number of events during peak hours (9:00 to 5:00))
aas_ip_first_event
   (time of first event)
aas_ip_last_event
   (time of last event)
aas_ip_WorkingHours
   (number of hours active).

Referring again to FIG. 5, the “onl_individual_profile” (online individual profile) database table is used to store data pertaining to each user's online activities (e.g. on the Internet). Each profile is uniquely identified by a “user ID” and date primary key. The profile information is obtained by querying the “domains” table and iterating over the rows of queries that results.

Some example online individual profile features include the following:
onl_ip_peak_max_latency
   (maximum latency during peak hours (9:00-5:00))
onl_ip_peak_total_online_time
   (total time spent online)
onl_ip_peak_number_sessions
   (total no of sessions started during peak hours (9:00-5:00))
onl_ip_peak_total_number_hit
   (total number of hits in peak hours (9:00-5:00))
onl_ip_peak_total_web_content
   (total bytes of web content during peak hours (9:00-5:00)).

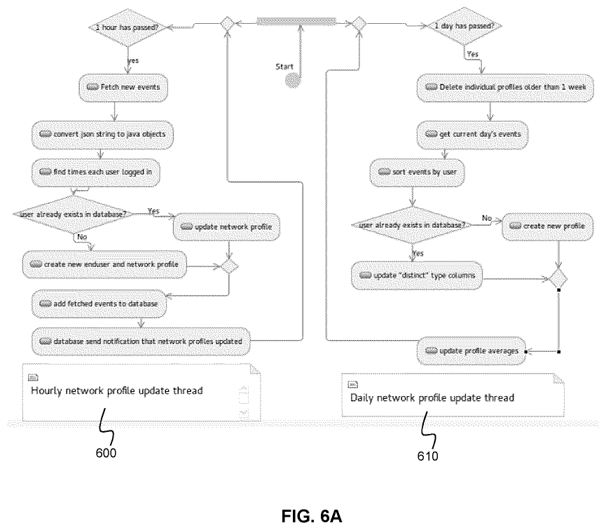

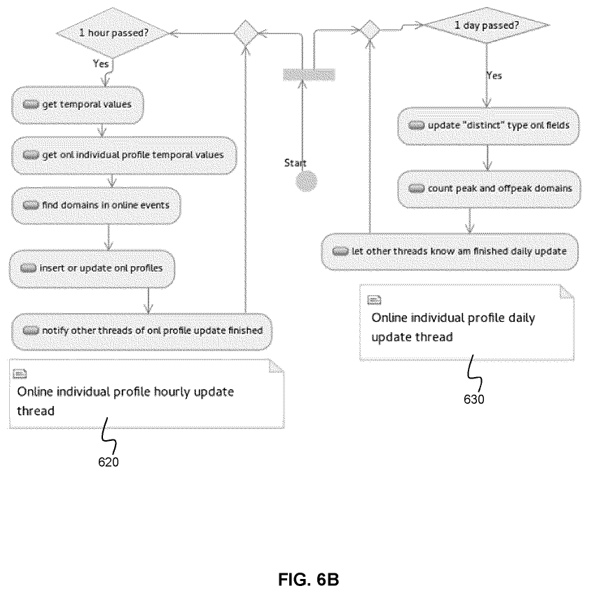

In one example implementation of the cybersecurity risk analysis subsystem, the risk assessment database may be updated on an hourly and/or daily basis. FIG. 6A provides an activities diagram illustrating an example process of creating and updating network individual profiles on an hourly 600 and daily 610 basis. FIG. 6B provides an activities diagram illustrating an example process of creating and updating online individual profiles on an hourly 620 and daily 630 basis. In the example implementation shown in FIG. 6B, hourly and daily updates may be provided for each “online” profile, as some features can only be calculated at the end of a day.

Referring again to FIG. 5, the user profiles (the user profile data) 510 are processed (e.g. classified) to generate a set of user groups 520. Each user group may have an associated group profile, and each group profile may be processed to determine an associated risk level. It will be understood that the user group classification may be generated based on historical user profile data stored over a prescribed time interval, such as over one month or one week, in order to perform classification based on behavior over a time interval. In one example, each user group may have a single numerical risk level associated therewith. In the non-limiting example shown in FIG. 5, the both network-specific user profiles 512 and online-specific user profiles 514 are generated.

For example, group profiles, or “clusters”, may be generated by querying the database for all individuals in the “online” and “network” profiles of a whole day, and inputting them to a clustering algorithm such as “DBScan” or “K-means”. According to such an example implementation, from the features of each group, or “cluster” a group profile is created such that the features of a group profile represent the centroid of the cluster (i.e. a profile of an imaginary “average” user in the group).

According to the example implementation shown in FIG. 5, network group profiles are stored in the database table “network_cluster”, and online group profiles are stored in the database table “online_cluster”. Each group profile may be uniquely identified using an ID number and date as the primary key. This information is stored in the “onl_cluster” and “network_cluster” tables which store information on group profiles for online and network activities respectively. To save which users belong in which clusters, the ID of each cluster and each user may be stored in the intermediate tables “user_onl_cluster” and “user_network_cluster”. Some example online (onl) group profile features include:
hits
   average number of times sites were visited for an average group member
peak_session_time
   time of most online activities for an average group member
peak_min_session_time
   minimum session time for group
peak_max_session_time
   maximum session time for group
total_web_content
   total web content downloaded for an average group member.
      Some example network group profile features include:
average_distinct_events
   number of distinct events for an average group member
workinghours
   time active for an average group member.

In some example embodiments, each user group may have an associated group profile (522, 526) that characterizes (e.g. parameterizes) the collective behavior of the group (e.g. on average). An example of such a group profile is shown at 524 for a user group determined based on network behavior (i.e. based on the processing of the network user profiles 512), and an online group profile is shown at 528. It will be understood, however, that while FIG. 5 illustrates an example implementation in which the separate user groups are computed on a network-specific and online-specific basis, in other example implementations, other types of user groups may be generated (per user group), or a single user group type (per user group) may be generated in the alternative.

The user groups may be determined (e.g. classified) according to a wide range of example methods, with the example user group categorization shown in FIG. 5 representing but one example. The user group profiles 524 and 528 shown in FIG. 5 are intended to show, for illustrative purposes, merely a portion (subset) of the user group profile data that could be generated for a given user group (for example, the list 524 does not end at the bottom of the window shown in the figure). The example user profile data shown in FIG. 5 was generated by processing user profile data obtained by cluster analysis. Cluster analysis or clustering is a method assigning a set of objects into groups (called clusters) so that the objects in the same cluster are more similar (in some sense or another) to each other than to those in other clusters. In the present example implementation, cluster analysis is employed for anomaly detection to facilitate the building of a model of normal behavior, and for the comparison of the model with captured behavior. Based on the size of deviation from the normal behavior or distance between the center of two clusters (e.g. if user moved from one cluster to another), it is possible to calculate the risk. In another example method of profiling and risk assessment, abnormal behavior patterns may be simulated in a laboratory and compared with the captured behavior, and the deviation and risk can be calculated (this method can have a low accuracy as it is not possible to simulate all abnormal behaviors in a laboratory setting).

To assess the risk of a given user, at least two security risk measures are generated, wherein a first security risk measure is generated by processing the user profile associated to the given user, and a second security risk measure is generated based on a detected change in the user's group (relative to a previous group status). For example, the second security risk measure may be generated based on a comparison between a current user group associated with the given user and a previous user group associated with the given user. A composite security risk measure may then be generated based on a combination of at least these two risk measures.

In some example embodiments, the contribution of the second security risk measure to the composite security risk measure associated with a given user increases when a risk level of the current user group exceeds a risk level of the previous user group. The magnitude of the contribution of the second security risk measure to the composite security risk measure may be dependent on a difference between the risk level of the current user group and the risk level of the previous user group associated with the given user. The risk level associated with a given user group may be generated according to a respective group profile associated with the given user group, where the respective group profile is generated based on the user profiles of the users belonging to the given user group.

The composite risk may be generated, as described below, based on a combination of the first and second security risk measures. It will be understood that the composite risk measure may be generated by any suitable functional relationship involving the first and second security risk measures, and that other factors, measures, coefficients, parameters, or terms may be included in the composite security risk measure in addition to the first and second security risk measures.

In some example embodiments, as described above, the processing of the user profiles to classify the users into a plurality of user groups may include the processing the online user profiles to classify the users into a plurality of online user groups, with each online user group having an associated risk level, and the processing the network user profiles to classify the users into a plurality of network user groups, with each network user group having a different associated risk level, where the online user groups and the network user groups are stored in the risk assessment database. According to such an example embodiment, when generating the composite security risk measure associated with the given user, the second security risk measure may be generated based on a comparison between a current online user group associated with the given user and a previous online user group associated with the given user, and also based on a comparison between a current network user group associated with the given user and a previous network user group associated with the given user.

As described in the example embodiments provided below, the risk analysis subsystem may be configured such that the first security risk measure is generated, for the given user, at least in part, by processing the user profile associated with the given user according to a set of predetermined rules to determine, for the given user, a set of threats, each threat having a respective threat score associated therewith. The threat scores may then be processed to generate the first security risk measure.

The first security risk measure, and the threats associated therewith, may be generated by identifying a set of vulnerabilities associated with the given user, where the set of threats are determined according to a pre-established association between vulnerabilities and threats. Examples of such association between vulnerabilities and threats are provided in the examples below. In some example implementations, each vulnerability may further have a vulnerability score associated therewith, and the vulnerability scores may be combined with (e.g. multiplied by) the threat scores of their corresponding threats when generating the first security risk measure. An example of such a computation of the first security risk measure is provided in detail below. The vulnerabilities associated with the given user may include one or more behavioral vulnerabilities that are determined by processing the user profile, and/or one or more common vulnerabilities based on one or more of hardware and software associated with the given user.

The risk analysis subsystem may also be configured such that each threat has an associated impact score, and where the threat scores are combined with their respectively associated impact scores when generating the first security risk measure. In another example implementation, the first security risk measure may be generated, in part, according to a user power measure. The user power measure may be generated, for example, according to a product of a user expertise measure, a user access power measure, and a measure of a user's role in a company.

In one example and non-limiting embodiment, the composite security risk calculation may be performed, for a given user, as follows. The following terms are employed in the example calculation provided below:
R: risk value
Up: user power
G_{P}: Group Profiling
Exp: expertise
AP: access power
Role: role in organization
Off: offenses
t: threat event (CAPEC standard)
CV: asset vulnerability (CVE standard)
VB: vulnerable behavior
I=impact of threat

According to the present example embodiment, the risk R of a single user is calculated using the following formula:

R≡Uₚ*Gₚ*T*I,

where
Uₚ is the “power of user”, or their capacity to affect the outcome of an event
Gₚ is the second risk measure based on the deviation of the user from the main group to which the user belongs
T*I is based on the summation of each threat multiplied by its vulnerabilities and impact, for the given user.
   According to the present example embodiment, Uₚ is calculated as follows:

Uₚ≡Exp°AP°Role

### Where:

Exp is the expertise of the user;
AP is the users access power; and
Role is the user's role in the company.
   T°I is calculated as follows:

T°I≡Σᵢ₌₁ⁿtᵢ(Σⱼ₌₁^{m}CVᵢⱼ+Σₖ₌₁^{P}VBᵢₖ)+Iᵢ,

### Where:

tᵢ is a Threat event (CAPEC standard);
CVᵢⱼ is the Asset's Vulnerability (CVE standard);
VBᵢₖ is the users Behavior Vulnerability (online and network behavior); and
Iᵢ is the Impact of a threat.

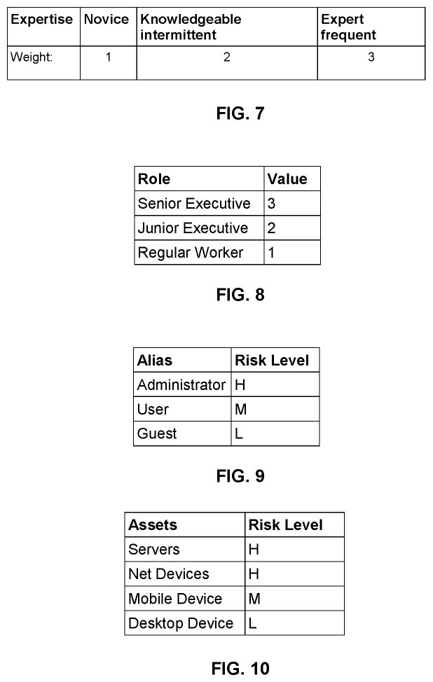

In order to explain the preceding example risk calculation method further, a specific risk calculation example for an example user is provided below. The first step in calculating risk is to calculate Uₚ. The variable Exp in the Uₚformula is found using a table defined by the organization. An example table is provided in FIG. 7. In one example, supposing that the user is an expert, Exp=3 would be selected according to FIG. 7.

The variable Role (Role in Company) is also found using a table defined by the organization. An example table is provided in FIG. 8. For example, suppose the user is a junior executive, then Role=2 would be employed.

The variable AP (Access Power) is defined as Access Power=Alias*Assets. AP is found by looking in three tables, “Alias-Risk Level”, “Assets-Risk Level”, and “Access Power”.

Firstly, the risk level of the user is found using an “Alias-Risk Level” table, for example, according to the example table shown in FIG. 9. For example, supposing that the example user has an administrator account at his/her workstation, then the risk level is H.

Secondly, a risk level is chosen from an Assets-Risk Level table depending on the assets to which the user has access. Supposing that the example user has a desktop computer at their office, let their risk level would be L according to the example table shown in FIG. 10.

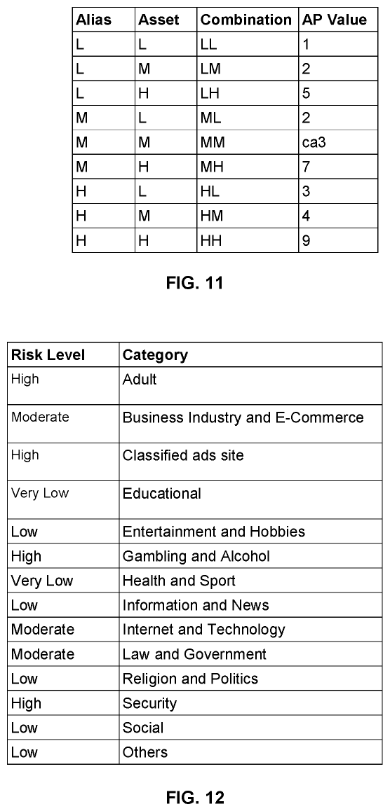

Finally, an AP (Access Power) value is found by looking up the row corresponding both the to the Risk levels from the Asset and Alias tables. Because the example user has an “alias risk level” of “H” and an “asset risk level” of “L”, they therefore have AP=3, as shown in table provided in FIG. 11.

With all variables known, Uₚ may now be calculated using:

Uₚ≡Exp*AP*Rol,

The result for the power of the example user is: Uₚ≡((3*3*2)/9)+1=2.33, with division by nine resulting from having nine rows in the “Access Power” table.

The second security risk measure, Gₚ, may then be calculated. Based on the one-month users' activities the group activities can be clustered using an Al algorithm such as K-means or DBScan. The present inventors have found that advantageous features for clustering the user's activities are the number of visited websites and the length of visiting sessions for each website. For labeling the type of websites and calculate the risk score of each website, one can employ, for example, the IBM X-force. The table shown in FIG. 12 shows the level of risk for each category of X-force.

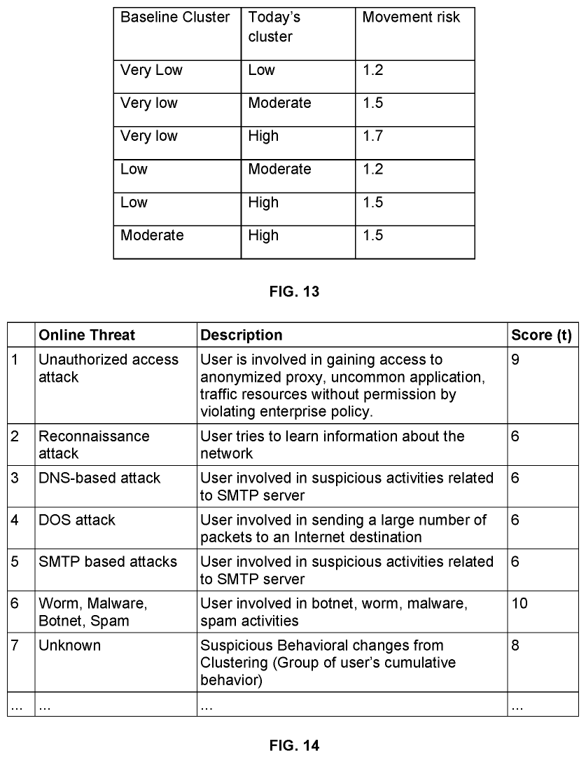

After clustering the group activities for the first month, the data can be re-clustered for each date and compared with the first baseline. For each deviation, the risk can be calculated based on the table shown in FIG. 13. If the user does not have any deviation, then Gₚ=1 is employed. In one example, if the user moved from the “Low” to the “Moderate” today, then his Gₚ=1.2.

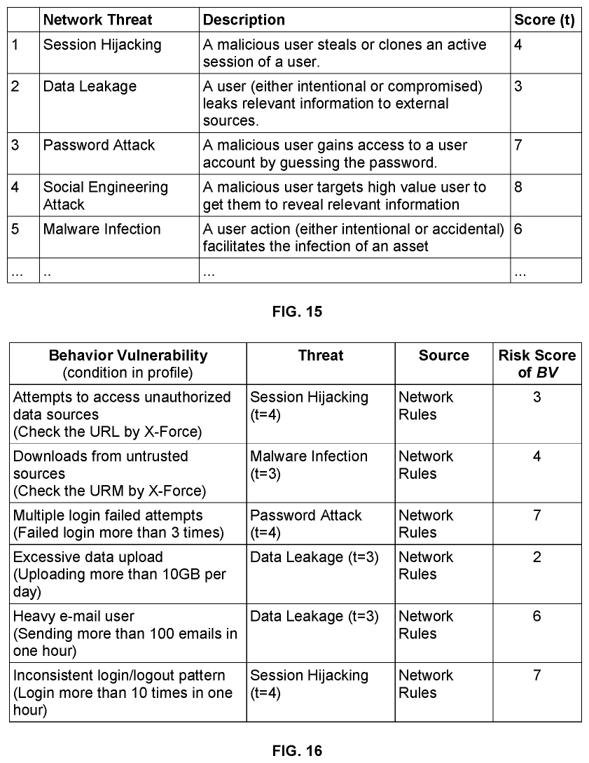

The next step in calculating a users risk is to find T*I. Each possible vulnerability is associated with one or more threats (tᵢ). For each vulnerability the user has, the threats associated with that vulnerability are added to that user's list of threats (t₀. . . tₙ,) if they are not already included. Some example threats are listed in the tables shown in FIGS. 14 and 15.

Behavior Vulnerabilities (BV) are vulnerabilities associated with organization defined rules, triggered when conditions in a user profile are met. In a manner similar to IDS/IPs systems, an organization may define a set of rules based on their normal behavior patterns to identify the list of deviations and abnormal activities within a period of time. The table presented in FIG. 16 shows some of the vulnerable behaviors and the related rules along with their threats and BV scores. The BV's scores are based on how danger a BV is for an organization, which can be different from organization to organization. It will be understood that the behavior vulnerabilities can be determined, for a given user, by processing the user profile data associated with the given user, according to the set of rules.

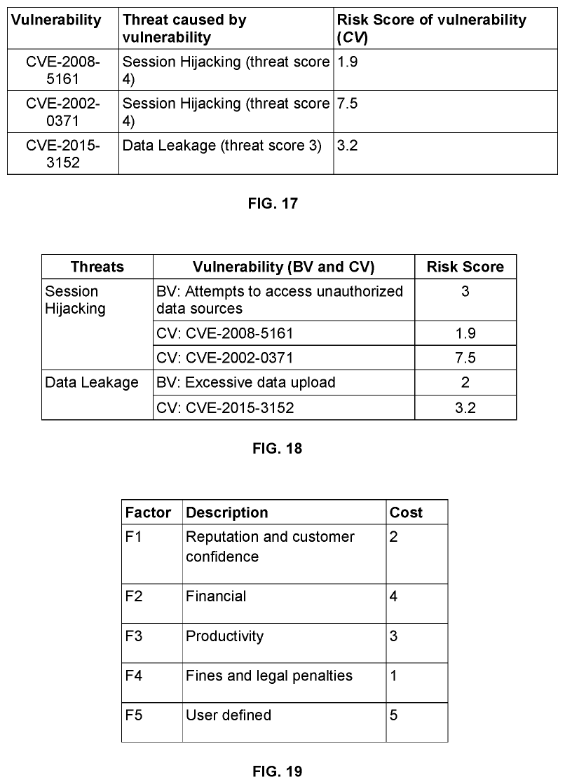

Common Vulnerabilities (CV) are standard vulnerabilities related to the user's machine and include, for example, the Operating System (OS) and all installed software's and the application's vulnerabilities which are already listed in the Mitre website (http://CVE.Mitre.org). The table shown in FIG. 17 provides a sample relation between some common vulnerabilities, and the threat and risk score associated with them.

For example, assuming a case where a user has the following three common vulnerabilities: CVE-2008-5161, CVE-2002-0371, and CVE-2015-3152, FIG. 17 indicates that this user has the following set of CVs {(1.9), (7.5), (3.2)} and a set of threats T{4, 3}. Also, assuming that the same user triggered the following two behavioral vulnerability rules: 1) attempts to access unauthorized data sources (threat=Session Hijacking) and 2) excessive data upload in one day (threat=Data Leakage), then this user would have a set of BVs {(3), (2)} and a set of threats T{4, 3}. The table shown in FIG. 18 presents the five vulnerabilities of the sample case with three CVs and two BVs.

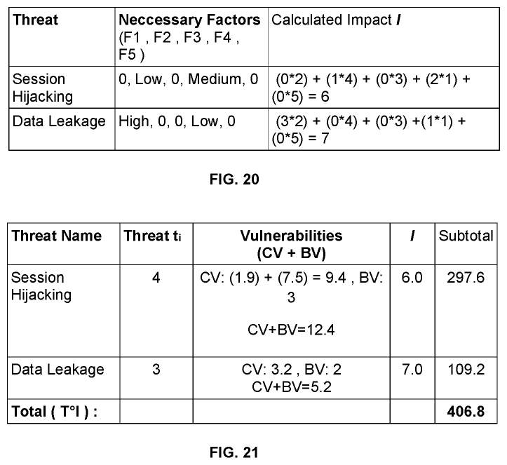

The impact I of each threat is a measure of the cost to the organization utilizing the risk assessment system. For example, I may be based on factors defined in the Octave standard and is summarized in the table shown in FIG. 19, where the various levels of impact are defined in the table shown in FIG. 20.

In the present non-limiting example method, the impact of each threat is calculated as the cost of each Octave factor times the weight of the factor for the threat. For example, if threat Session Hijacking has a “Low” weight in factor F2, and a medium weight on factor F4, then the impact of the threat is (Low*F2 cost)+(Medium*F4 cost)=(1*4)+(2*1)=6=I, as illustrated in the table presented in FIG. 20.

The security risk measure T*I may be calculated as follows:

T*I≡Σᵢ₌₁ⁿtᵢ(Σⱼ₌₁^{m}CVᵢⱼ+Σₖ₌₁^{p}BVᵢₖ)*Iᵢ

In the present example implementation, T*I is calculated by iterating over for each of the users threats and finding the product of the threat impact and weight multiplied by the sum of the user's vulnerability weights (CV and BV) for that threat. The results for each threat are summed together for a total T*I. The procedure is illustrated in a table format (going row by row then adding the subtotals) in FIG. 21.

It will be understood that the equation provided above is merely an example of the calculation of the product of T*I, and that it is not intended to be limiting. For example, since threats are associated with the vulnerabilities of a user, the equation provided above could be recast with an outer sum based on vulnerabilities associated with a given user, and an inner sum based on threats associated with those vulnerabilities.

With Uₚ and T*I known, the composite security risk measure R may be calculated. In the given example, the risk measures associated with the example user are as follows:
Uₚ=2.3
Gₚ=1.2
T°I=406.7
   Therefore, the composite security risk measure is calculated for this user as R≡Uₚ*Gₚ*T*I=1112.

After the risk value has been calculated for a user, it may be normalized for comparability using the following formula:

R=1000*(1−e^{-λX})

where:
X is the real value of risk found previously; and
λ is a scaling factor chosen according to the number of users.

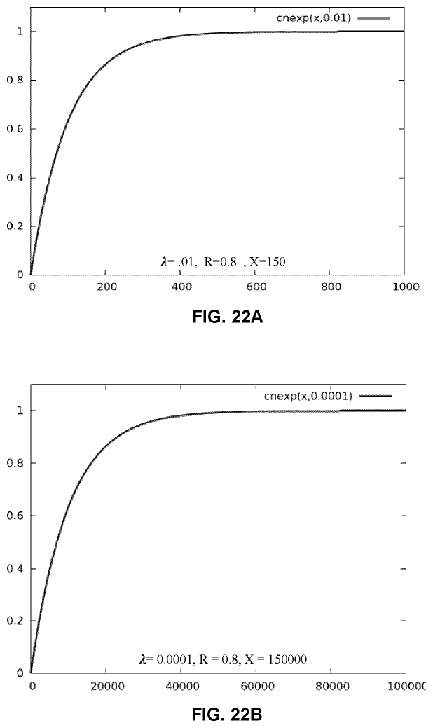

In one example implementation, the variable λ can be selected automatically by threshold. Accordingly, as the number of users is increased, λ should be decreased. For example, λ=0.01 for 100 users and λ=0.0001 for 1000 users. An example scaling is shown in FIGS. 22A and 22, where, in FIG. 22A, the scaling parameters are λ=0.01, R=0.8, X=150 in FIG. 22B and λ=0.0001, R=0.8, X=150000.

In some example embodiments, a risk profile may be generated for a given user. The risk profile for a given user may consist of the primary key of the user and a breakdown of factors contributing to the final risk value (such as any one or more of the parameters determined in the preceding example), as illustrated in FIG. 4 by the table user risk. For example, an individual risk profile may include one or more the following features:
user_risk_username
   name of user
user_risk_date
   date risk calculated
user_risk_threat_count
   number of threats caused by user
user_risk_riskvalue
   final composite security risk score calculated for user
user_risk_vulnerability_rules
   Number of vulnerabilities caused by triggering various conditions in the users individual profile.

Having determined the risk of each user, the risk analysis subsystem can then recommend risk mitigation action to an administrator on a per case basis. For example, one recommendation can be proposed for a user with high network traffic and another recommendation can offer to a user with abnormal working hours.

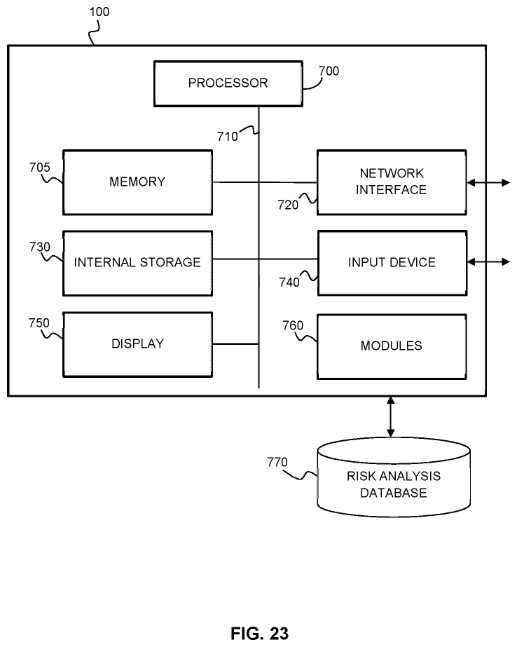

FIG. 23 illustrates a non-limiting example embodiment of the risk analysis subsystem 100. The risk analysis subsystem 100 may be any suitable computing device, such as a personal computer, rack-mounted computing equipment, or a specialty purpose computing device. FIG. 23 illustrates one example implementation in which the risk analysis subsystem 100 includes hardware such as one or more processors 700 and associated memory 705, bus 710, a network interface 720, an optional display 750 (e.g. for displaying a graphical user interface), an optional input device 740 (e.g. a keyboard) and optional internal storage 730. In one example implementation, the risk analysis database may reside, at least in part, in internal storage 730. Alternatively, as illustrated in FIG. 23, the risk analysis database may reside, at least in part, in one or more external storage devices 770 (e.g. an external hard drive or server). Modules 760, such as modules 112, 114 and 116 of FIG. 1, are stored as computer-readable instructions in memory 705 and executed by the one or more processors 470.

The network interface 720 may include devices for communicating with computing devices residing within the monitored network (and optionally computing devices accessible through the external network. For example, the network interface 720 may include wireless network transceivers (e.g., Wi-Fi™, Bluetooth), wired network interfaces (e.g., a CAT-type interface), USB, FireWire, or other known interfaces. The network interface 720 may provide connections to the monitored network and to other entities of the system using standard communication protocols.

Although only one of each component is illustrated in FIG. 23, any number of each component can be included in risk analysis subsystem 100. For example, a computer typically contains a number of different data storage media. Furthermore, although the bus 710 is depicted as a single connection between all of the components, it will be appreciated that the bus 710 may represent one or more circuits, devices or communication channels which link two or more of the components. For example, in many computers, bus 710 often includes or is a motherboard.

While some embodiments can be implemented in fully functioning computers and computer systems, various embodiments are capable of being distributed as a computing product in a variety of forms and are capable of being applied regardless of the particular type of machine or computer readable media used to actually effect the distribution.

At least some aspects disclosed can be embodied, at least in part, in software. That is, the techniques may be carried out in a computer system or other data processing system in response to its processor, such as a microprocessor, executing sequences of instructions contained in a memory, such as ROM, volatile RAM, non-volatile memory, cache or a remote storage device.

A computer readable storage medium can be used to store software and data which when executed by a data processing system causes the system to perform various methods. The executable software and data may be stored in various places including for example ROM, volatile RAM, nonvolatile memory and/or cache. Portions of this software and/or data may be stored in any one of these storage devices. As used herein, the phrases “computer readable material” and “computer readable storage medium” refers to all computer-readable media, except for a transitory propagating signal per se.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

1. A system for assessing security risk associated with a computer network, the system comprising:
a risk assessment database; and
a risk analysis subsystem operably connected to said risk assessment database and one or more data sources, wherein the one or more data sources comprise user activity data, wherein the risk analysis system comprises at least one processor and associated memory, wherein the memory stores instructions executable by the at least one processor for performing operations comprising:
monitoring the one or more data sources to obtain user activity data associated with users of the computer network;
processing the user activity data to generate a plurality of user profiles, wherein each user profile is associated with a respective user;
processing the user profiles to classify the users into a plurality of user groups, each user group having an associated risk level;
storing the user profiles and the user groups in the risk assessment database; and
generating a composite security risk measure associated with a given user, wherein the composite security risk measure is generated, at least in part, by combining:
a first security risk measure generated by processing the user profile associated with the given user; and
a second security risk measure based on a comparison between a current user group associated with the given user and a previous user group associated with the given user.

2. The system according to claim 1 wherein the risk analysis subsystem is configured such that the contribution of the second security risk measure to the composite security risk measure increases when a risk level of the current user group exceeds a risk level of the previous user group.

3. The system according to claim 2 wherein the risk analysis subsystem is configured such that a magnitude of the contribution of the second security risk measure to the composite security risk measure is dependent on a difference between the risk level of the current user group and the risk level of the previous user group.

4. The system according to claim 1 wherein the risk analysis subsystem is configured to communicate the associated security risk when the composite security risk measure associated with the given user exceeds a threshold.

5. The system according to claim 1 wherein the risk analysis subsystem is configured such that the plurality of user profiles are recalculated at least as frequently as once per hour.

6. The system according to any claim 1 wherein the risk analysis subsystem is configured such that the plurality of user profiles are recalculated more frequently than the plurality of user groups.

7. The system according to claim 1 wherein the risk analysis subsystem is configured such that the plurality of user groups are recalculated at least as frequently as once per day.

8. The system according to claim 1 wherein the risk analysis subsystem is configured such that the plurality of user groups are calculated, at least in part, based on historical user profile data.

9. The system according to claim 8 wherein the risk analysis subsystem is configured such that the historical user profile data comprises, for at least one user, a plurality of user profile records generated in the past and stored in the risk assessment database.

10. The system according to claim 1 wherein the risk analysis subsystem is configured such that the plurality of user groups are determined according to a clustering algorithm.

11. The system according to claim 1 wherein the risk analysis subsystem is configured such that a risk level associated with a given user group is generated according to a respective group profile associated with the given user group, wherein the respective group profile is generated based on the user profiles of the users belonging to the given user group.

12. The system according to claim 1 wherein the risk analysis system is further configured such that the one or more data sources are monitored to detect online activity and network user activity associated with users of the computer network, wherein the online user activity data associated with a given user is associated with online interactions involving the given user and a remote network that is interfaced with the computer network, and wherein the network user activity data associated with a given user is associated with offline interactions involving the given user and the computer network in the absence of interaction with the remote network.

13. The system according to claim 12 wherein the risk analysis subsystem is configured such that processing the user activity data to generate a plurality of user profiles comprises:
processing the online user activity data to generate a plurality of online user profiles;
processing the network user activity data to generate a plurality of network user profiles; and
storing the online user profiles and the network user profiles in the risk assessment database; and
wherein, when generating the composite security risk measure associated with the given user, the first security risk measure generated by processing the online user profile associated with the given user and the network user profile associated with the given user.

14. The system according to claim 12 wherein the risk analysis subsystem is configured such that processing the user profiles to classify the users into a plurality of user groups comprises:
processing the online user profiles to classify the users into a plurality of online user groups, each online user group having an associated risk level;
processing the network user profiles to classify the users into a plurality of network user groups, each network user group having a different associated risk level; and
storing the online user groups and the network user groups in the risk assessment database; and
wherein, when generating the composite security risk measure associated with the given user, the second security risk measure is generated based on:
a comparison between a current online user group associated with the given user and a previous online user group associated with the given user; and
a comparison between a current network user group associated with the given user and a previous network user group associated with the given user.

15. The system according to claim 1 wherein the risk analysis subsystem is configured such that the first security risk measure is generated, for the given user, at least in part, by:
processing the user profile associated with the given user according to a set of predetermined rules to determine, for the given user, a set of threats, each threat having a respective threat score associated therewith; and
processing the threat scores to generate the first security risk measure.

16. The system according to claim 15 wherein the risk analysis subsystem is configured such that the set of threats are determined by:
identifying a set of vulnerabilities associated with the given user, and determining the set of threats according to a pre-established association between vulnerabilities and threats.

17. The system according to claim 16 wherein the risk analysis subsystem is configured such that each vulnerability has a vulnerability score associated therewith, and wherein the vulnerability scores are combined with the threat scores of their corresponding threats when generating the first security risk measure.

18. The system according to claim 16 wherein the risk analysis subsystem is configured such that the vulnerabilities associated with the given user comprise behavioral vulnerabilities that are determined by processing the user profile.

19. The system according to claim 18 wherein the risk analysis subsystem is configured such that the vulnerabilities associated with given user further comprise common vulnerabilities based on one or more of hardware and software associated with the given user.

20. The system according to claim 15 wherein the risk analysis subsystem is configured such that each threat has an impact score associated therewith, and wherein the threat scores are combined with their respectively associated impact scores when generating the first security risk measure.

21. The system according to claim 1 wherein the risk analysis subsystem is configured such that the first security risk measure is generated in part according to a user power measure.

22. The system according to claim 21 wherein the risk analysis subsystem is configured such that the user power measure is generated according to a product of a user expertise measure, a user access power measure, and a measure of a user's role in a company.

23. The system according to claim 1 wherein the risk analysis subsystem is further configured to generate and provide a risk mitigation recommendation and/or perform a risk mitigation action based on the composite security risk measure associated with the given user.

24. A method for assessing security risk associated with a computer network, the method comprising:
monitoring the one or more data sources to detect user activity data associated with users of the computer network;
processing the user activity data to generate a plurality of user profiles, wherein each user profile is associated with a respective user;
processing the user profiles to classify the users into a plurality of user groups, each user group having a different associated risk level;
storing the user profiles and the user groups in a risk assessment database; and
generating a composite security risk measure associated with a given user, wherein the composite security risk measure is generated, at least in part, by combining:
a first security risk measure generated by processing the user profile associated with the given user; and
a second security risk measure based on a comparison between a current user group associated with the given user and a previous user group associated with the given user.

25-46. (canceled)
